(19) United States
(12) Patent Application Publication
(10) Pub. No.: US 2013/0295427 A1
(43) Pub. Date: Nov. 7, 2013

(54) ELECTROCHEMICAL CELL

(71) Applicant: Li-Tec Battery GmbH, Kamenz (DE)

(72) Inventors: Torsten SCHMIDT, Landsberg (DE); Christian ZAHN, Dresden (DE); Tim SCHAEFER, Harztor (DE); Iris STIEBERT, Dresden (DE); Stefan BEIER, Lommatzsch (DE); Steffen LEGNER, Ellwangen (DE)

(21) Appl. No.: 13/935,965

(22) Filed: Jul. 5, 2013

Related U.S. Application Data
(63) Continuation of application No. 13/698,890.

(30) Foreign Application Priority Data
May 20, 2010 (DE) 10 2010 022 217.8

(51) Int. Cl. H01M 2/10

(52) U.S. Cl. CPC H01M 2/1016; H01M 2/1022; H01M 2/1072
USPC 429/99; 429/96

(57) ABSTRACT

An electrochemical cell is proposed having an electrical unit, a first frame part and a second frame part, wherein the electrical unit is clamped in the area of the clamping surfaces between the first frame part and the second frame part, characterized in that the electrical energy unit and the first frame part have shape features which match one another and engage in one another such that a relative position of the electrical unit with respect to the first frame part is at least substantially fixed, at least in a state in which the clamping assembly of the frame parts and the electrical unit is released. This allows the electrical unit to be prefixed in the first frame part before production of the clamping assembly, making it possible to prevent the electrical unit from being installed obliquely.

The present invention relates to an electrochemical cell according to the preamble of claim 1, and to an arrangement of electrochemical cells.

### PRIOR ART

Electrochemical cells (in particular battery or rechargeable-battery cells) having an electrical unit, a first frame part and a second frame part are known in which the electrical unit is clamped in the area of clamping surfaces between the first frame part and the second frame part. Typically, but not necessarily, the electrical unit is formed by a film stack or film coil which is welded into a wrapper and has electrochemically active electrode films, separator films and current-collecting films, the wrapper forming a peripheral, flat, welded edge (also referred to as a sealing seam), which projects from the narrow sides of the film stack or film coil as a peripheral web, conductors which are connected to the current-collecting films projecting outwards through the wrapper. During assembly, the electrical unit is placed between the frame parts and the frame parts are for example screw-fastened or riveted, so that thicker sections of the frame parts clamp the sealing seam of the electrical unit. A soft component such as for example an inlay or the like can fix the cell by means of frictional adhesion and limit the mechanical load.

In this case the cell may be installed into the frame in a skewed or displaced manner. The conductors and therefore also the cell can then be damaged owing to shear forces. Owing to the setting behaviour of the soft components, the cell may slip in the frame and therefore the wrapper may be damaged by tearing and/or the cell may be damaged by tensile forces on the conductors.

### SUMMARY OF THE INVENTION

It is an object of the present invention to improve the structure according to the prior art in particular (but not only) with regard to the previously mentioned aspects.

The object is achieved by the features of the independent claims. Advantageous developments of the invention form the subject of the subclaims.

According to one aspect of the invention, an electrochemical cell having an electrical unit, a first frame part and a second frame part is proposed, the electrical unit being clamped in the area of clamping surfaces between the first frame part and the second frame part, characterised in that the electrical energy unit and the first frame part have shape features which match one another and engage in one another in such a manner that a relative position of the electrical unit with respect to the first frame part is at least substantially fixed, at least in a state in which the clamping assembly of the frame parts and the electrical unit is released.

An electrochemical cell within the meaning of the invention may mean any device which is also designed and set up to output electrical energy. In this case, an electrical unit means an inherently structurally closed module which fulfils the electrical properties of energy storage and energy output, and frame parts mean components which together accommodate the electrical unit and define a mechanically stable outer contour of the cell. The electrical unit can in particular, but not only, be an electrochemical storage cell of the primary or secondary type (battery or rechargeable-battery cell), a fuel cell or a capacitor cell.

If according to the invention, the electrical energy unit and the first frame part have shape features which match one another and engage in one another in such a manner that a relative position of the electrical unit with respect to the first frame part is at least substantially fixed at least in a state in which the clamping assembly of the frame parts and electrical unit is released, the electrical energy unit is prefixed when the electrical energy unit is inserted into the frame (the first frame part). It is thereby no longer possible to install the electrical energy unit into the frame in a skewed or displaced manner. The electrical energy unit can be installed in the frame in a secure and permanently positionally stable manner.

In a preferred embodiment, it is provided for the shape features of the electrical unit to be formed in an electrically inactive edge region of the electrical unit. If an electrically inactive edge region is accordingly reserved for the form-fitting retention of the electrical unit, an electrochemically active part can be kept free of mechanical stresses and electrochemical processes can proceed without interference.

In a preferred embodiment, it is provided for the electrical unit to have an electrochemically active part, which defines a substantially square, in particular flat basic shape, is formed from a film stack or coil and is surrounded in a leakproof manner by a film-like, insulating wrapper, the wrapper forming the edge region which preferably projects from narrow sides of the square-shaped basic shape. An electrochemically active part means the part within which charging, discharging and where applicable conversion processes of electrical energy take place. The active part can have film layers consisting of electrochemically active materials (electrodes), conductive materials (current collectors) and separating materials (separators). A leakproof wrapper within the context of the invention means a gas-, vapour- and liquid-tight wrapper, it also being possible for shielding from electromagnetic waves and pulses to be present. Conductors can also be provided, which are connected to current-collecting regions inside the electrochemically active part, which pass outwards through the wrapper and which in particular, but not necessarily, project from the cell in a flat shape. The invention can thus be applied preferably, but not exclusively, to flat rechargeable-battery cells. Without limiting the generality, it is preferred for the electrode materials to contain at least partially lithium or lithium compounds.

In a preferred embodiment, it is provided for the shape features of the electrical unit to have recesses which are formed in an edge region of the electrical unit, and for the shape features of the first frame part to have elevations which fill the recesses. In this manner it is possible effectively to create an engagement of shape features in such a manner that a relative position of the electrical unit with respect to the first frame part is at least substantially fixed.

A configuration which is simple to produce can be created if the elevations and the recesses have an at least substantially circular cross section, the recesses preferably forming a hole pattern.

If the elevations are formed integrally on the respective frame part, the number of individual parts to be assembled is particularly small. In contrast, it can be advantageous from a manufacturing standpoint if the elevations are elements, preferably pins or bolts, which are accommodated in receptacles in the respective frame part and which are particularly preferably produced from a less resilient material than the frame parts.

In a further configuration, it is provided for the recesses to have notches on the edges and the notches to have a shape which follows the recesses. With such a configuration the assembly, in particular the insertion of the electrical unit into the first frame part, is particularly simple.

In a development of the invention, it is provided for the second frame part to have depressions which receive the elevations of the first frame part. In this manner, the relative position of the second frame part can be fixed with the same shape features which are provided for aligning the electrical unit on the first frame part.

In a further configuration of the invention, it is provided for the shape features of the electrical unit to have embossed portions which are formed in an edge region of the electrical unit, and the shape features of the first frame part to be elevations and/or depressions which follow the embossed portions, the second frame part preferably having depressions and/or elevations which follow the embossed portions. Such a configuration of the shape features is comparatively simple to realise, particularly on the side of the electrical unit. Assembly, in particular the insertion of the electrical unit into the first frame part, is likewise particularly simple. The number of individual parts is small.

An elastic prestress and damping of the electrical unit can be realised with a soft component which is provided between the clamping surfaces of the electrical unit and the frame parts, the soft component being elastically compressed in a state in which the clamping assembly of the frame parts and electrical unit is produced. Mechanical loads owing to vibrations and impacts can thus be reduced.

In a development of the invention, it is provided for the first frame part and the second frame part to be connected to each other detachably, in particular by screw fastening, or non-detachably, in particular by riveting, in order to create a secure connection.

In an alternative it is provided for a sprung locking device to be provided, which snaps in when the first and second frame parts are joined and thereby prevents the first frame part from becoming detached from the second frame part, the locking device preferably being realised by at least some of the shape features, in particular by elevations and depressions in the first and second frame parts. Such a configuration makes it possible for the frame parts to be detached and reconnected, which also contributes to the ease of assembly and maintenance.

In a development of the invention, it is provided for the first frame part and the second frame part to be connected to each other by means of a hinge device. Such a configuration can further reduce the number of parts. A position of the frame parts with respect to each other can also be securely defined and handling made easier.

According to a further aspect of the invention, an arrangement of electrochemical cells is proposed, in which the electrochemical cells are formed according to one of the preceding claims.

The previous and further features, objects and advantages of the present invention will become clearer from the following description, which has been prepared with reference to the attached drawings.

### SHORT DESCRIPTION OF THE DRAWINGS

In the drawings:

FIG. 1 is an end view of a battery cell in an exemplary embodiment of the present invention;

FIG. 2 is a plan view of the battery cell of FIG. 1;

FIG. 3 is a perspective view of the battery cell of FIGS. 1 and 2;

FIG. 4 is an exploded view of the battery cell of FIG. 3;

FIG. 5 is an enlarged illustration of a detail V in FIG. 4;

FIG. 6 is a detailed section view of an edge region of a cell with two frame parts in a variant of the present invention, the section and the viewing direction being indicated by a line and an arrow direction VI in FIG. 1; and

FIG. 7 is a detailed section view of a lateral section of a battery cell in a two-part frame in a further variant of the present invention, the section and the viewing direction being indicated by a line and an arrow direction VII in FIG. 1.

It is to be pointed out that the illustrations in the figures are schematic and are limited to the reproduction of the most important features for the understanding of the invention. It is also to be pointed out that the dimensions and size ratios reproduced in the figures are solely based on the clarity of the illustration and are in no way to be understood as limiting unless something else should emerge from the description.

### PREFERRED EMBODIMENTS OF THE INVENTION

A preferred embodiment of the present invention and some variants are described in detail below with reference to the drawings.

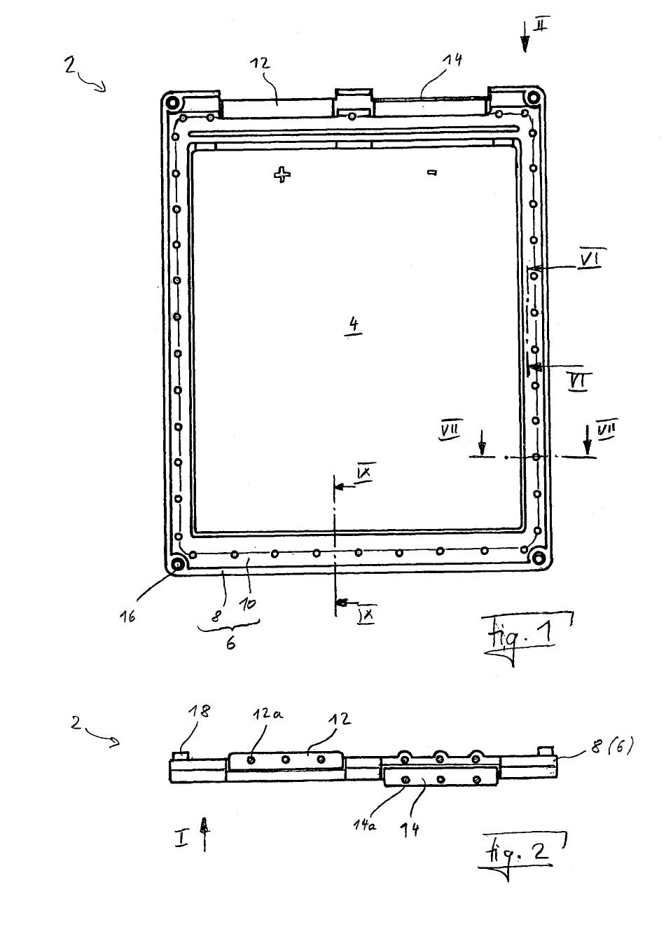

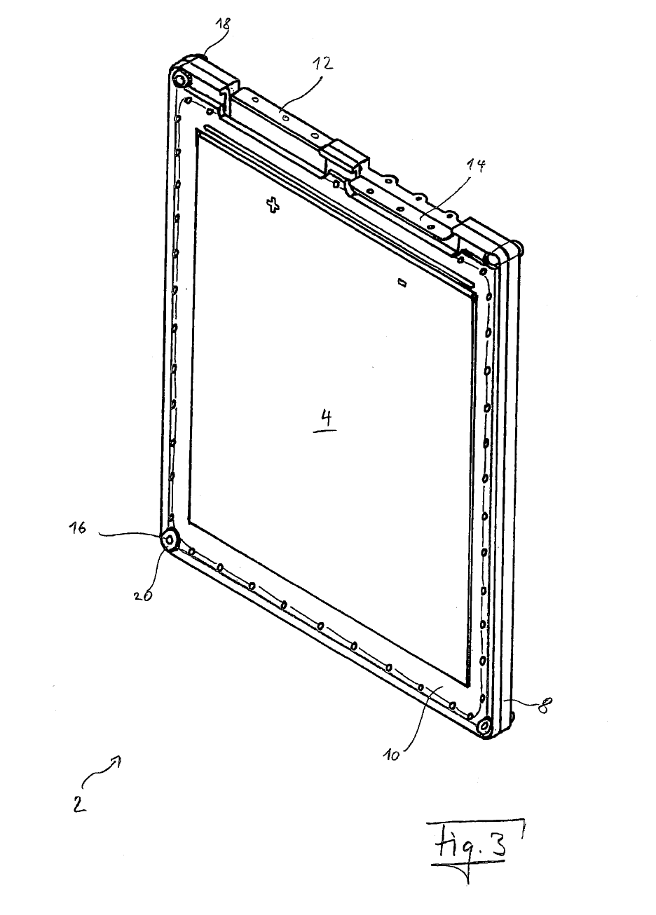

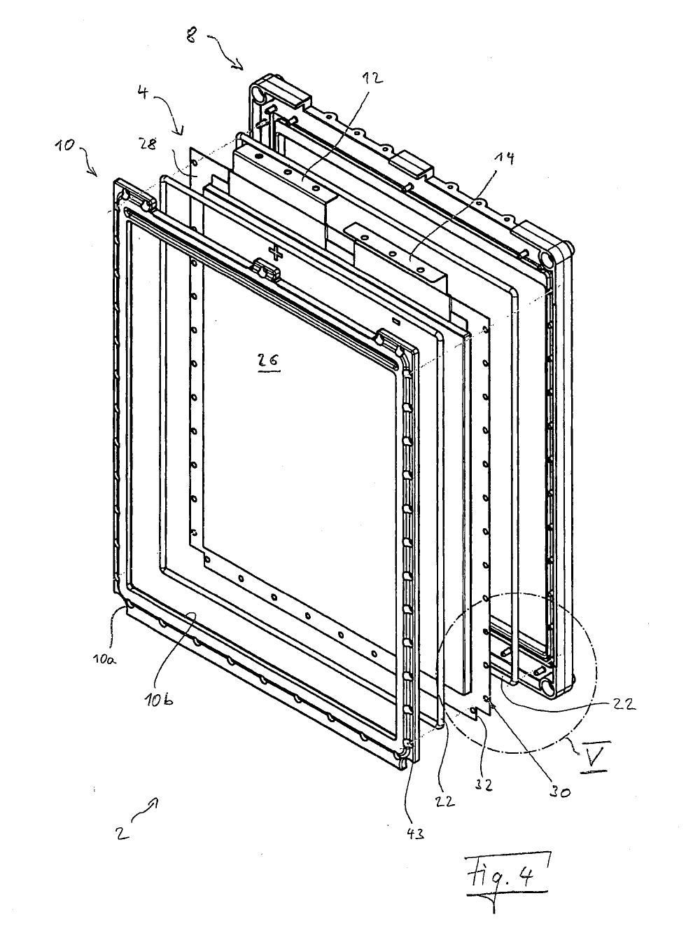

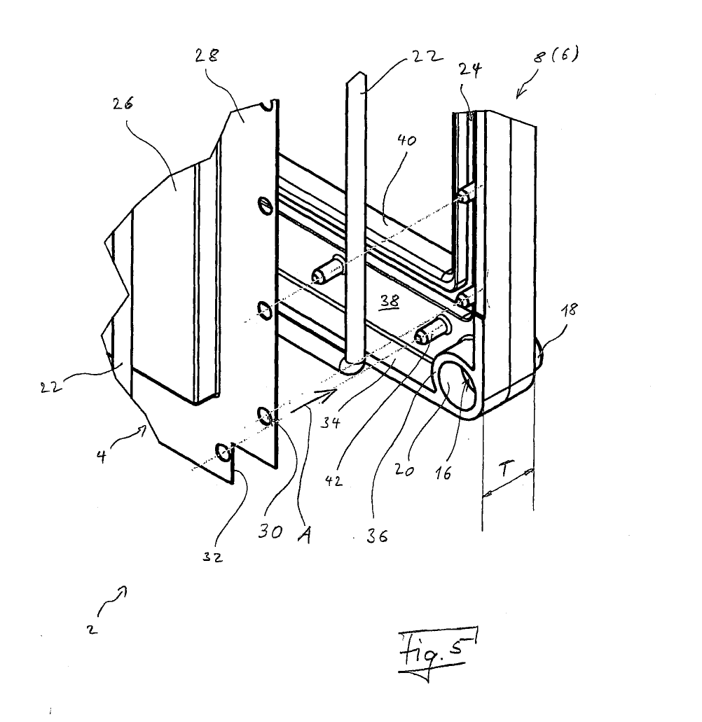

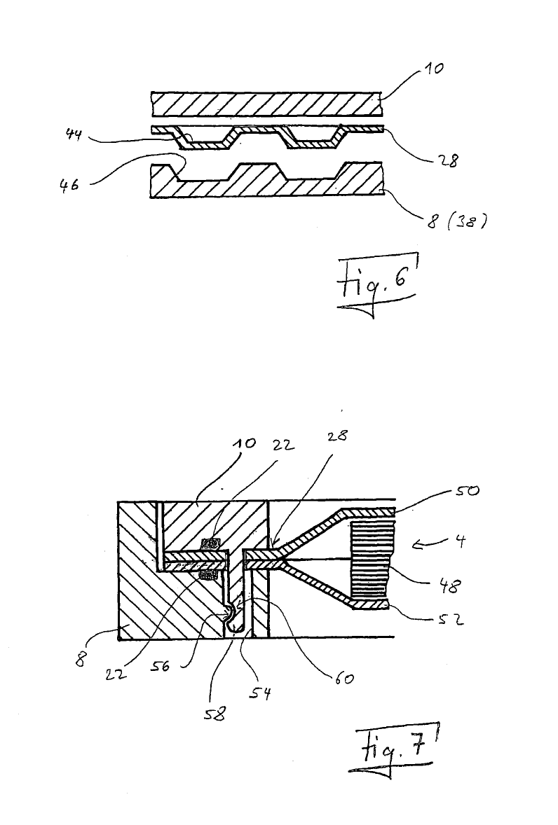

A basic exemplary embodiment of a battery cell of the present invention is first described using FIGS. 1 to 5. Here, FIG. 1 is an end view, FIG. 2 is a plan view, FIG. 3 is a perspective view, FIG. 4 is an exploded perspective view and FIG. 5 is a detailed view of a detail V in FIG. 4. A viewing direction in FIG. 1 is indicated by an arrow I in FIG. 2, and a viewing direction in FIG. 2 is indicated by an arrow II in FIG. 1.

According to the illustration in FIG. 1, a battery cell 2 has a battery element 4 and a frame 6, the frame 6 having a well part 8 and a cover part 10. Only an edge of the well part 8 is visible in FIG. 1, and the cover part 10 covers the remaining part of the well part 8 (actually the outer dimensions of the cover part 10 are matched to the edge of the well part 8 in such a manner that it can be inserted into the latter). A positive conductor 12 and a negative conductor 14 of the battery element 4 are situated in a freely accessible manner on the top of the battery cell 2.

In FIG. 1 the battery cell 2 can be seen from a front side; seen from this side, the positive conductor 12 is on the left-hand side and the negative conductor 14 is on the right-hand side.

According to the illustration in the plan view of FIG. 2, the conductors 12, 14 have tabs which point towards different sides and are provided with bores 12a, 14a. The positive conductor 12 points with its tab towards the rear of the battery cell 2, while the negative conductor 14 points with its tab towards the front of the battery cell.

Four assembly bores 16 (FIG. 1) are provided in the four corners in the well part 8 of the frame 6. Four knobs 18 (FIG. 2) are formed on the well part 8 of the frame 6 on the rear of the battery cell 2 in alignment with the assembly bores 16.

As can be seen from the perspective view of FIG. 3, depressions 20 which are aligned with the assembly bores 16 are provided on the front of the well part 8. It should be noted here that a depression depth of the depressions 20 is greater than the height of the knobs 18, and that, when a plurality of battery cells 2 are in the assembled state, the knobs 18 of one battery cell 2 in each case are inserted into the depressions 20 of an adjacent battery cell 2. In this manner, the battery cells 2 can be be placed in rows together such that they are secured against being rotated or displaced. When the required number of battery cells 2 has been placed in rows together, they can be screw-fastened by means of long screws which extend through the assembly bores 16.

The individual components of the battery cell 2 can be seen clearly in the exploded view of FIG. 4. In addition to the battery element 4, the well part 8 and the cover part 10, two elastomer rings 22 are provided, which are each arranged between the well part 8 and the battery element 4, and between the battery element 4 and the cover part 10. The elastomer rings 22 are produced from an elastic material, have a square shape and a round cross section.

According to the illustration in FIG. 4, the battery element 4 has a central part 26 and an edge part 28. The edge part 28 is much thinner than the central part 26. The battery element 4 is, without limiting the generality, a lithium-ion rechargeable-battery element of flat construction (also referred to as a coffee bag cell or pouch cell). The electrochemically active part of the battery element 4 is formed by a layer of films of different types, which are arranged in the form of a stack or a coil. The films comprise those with an electrode material which acts as an anode, those with an electrode material which acts as a cathode, electrically conductive current collector films for the anode and cathode films and separator films for separating the different electrode regions. The current collector films which are for example connected to the cathode films are connected to the positive current collector 12, which extends without limiting the generality in a central plane of the film stack away from the film stack, and the current collector films which are connected to the anode films are connected to the negative conductor 14, which likewise without limiting the generality extends in the central plane of the film stack away from the film stack. Two wrapper films enclose the electrode stack or electrode coil and are welded around the film stack or film coil in order to form what is known as the sealing seam, which is referred to here as the edge region 28. The conductors 12, 14 extend through the sealing seam of the two wrapper films; the inner region of the wrapper film is evacuated and otherwise closed off hermetically (in a gas-, vapour- and liquid-tight and where applicable also electromagnetically-shielded manner) from the environment by the wrapper films.

A plurality of holes 30 in the form of an at least substantially regular hole pattern are distributed in the edge region 28 of the battery element 4 over the three edges in which the conductors 12, 14 are not arranged. The function of these holes 30 is now explained in more detail using the detailed view of FIG. 5. FIG. 5 shows the well part 8 of the frame 6, the battery element 4 and the two elastomer rings 22 in the region of a bottom right-hand corner of the battery cell 2 in an enlarged manner. As can be seen in FIG. 5, the elastomer ring 22 runs in a groove 24 of the well part 8. The other elastomer ring 22 runs in a similarly constructed groove in the cover part (10, not shown in more detail here).

According to the illustration of FIG. 5, the well part 8 has an edge web 34, the height of which at the same time defines the total thickness T of the well part 8 and thus also of the frame 6 overall. The edge web 34 widens at the corners to form a ring web 36, which accommodates the bore 16 and the depression 20 and which finds a correspondence in the knobs 18 on the rear of the well part 18. Towards the inside of the ring web 34 a base 38 is attached, which on the one hand defines the rear of the well part 8 and the battery cell 2 overall and on the other hand forms a contact surface for the edge region 28 of the battery element 4. Further towards the inside, a window 40 is formed from the base 38, which window accommodates the thicker central part 26 of the battery element 4.

The edge region 28 of the battery element 4 has a notch 32 in its lower corners, which notch corresponds approximately to the space taken up by the ring web 36 of the well part 8 of the frame 6. A row of pins 42 are inserted into the base 38 of the well part 8 of the frame 6, the arrangement of which corresponds exactly to the pattern of the holes 30 in the edge part 28 of the battery element 4. As can be seen in FIG. 4, the cover part 10 also has a number of bores 43, the pattern of which corresponds to the arrangement of the pins 42 in the well part 8. Furthermore, the cover part 10 has projections 10a in its lower corners, the contour of which projections corresponds to the outer contour of the rib webs 36 of the well part 8. Finally, the cover part 10 has a window 10b, which receives the central part 26 of the battery element 4. The outer dimensions of the cover part 10 correspond to the inner dimensions of the edge web 34 of the well part 8.

When the battery cell 2 is assembled, first the well part 8 is prepared, the pins 42 are inserted into bores (not shown in any more detail) and one elastomer ring 22 is placed into the groove 24 in the well part 8. The battery element 4 is then inserted into the well part 8, the pins 42 of the well part 8 passing through the holes 30 in the edge region 28 of the battery element 4 (an arrow A in FIG. 5 indicates an assembly direction). A relative position of the battery element 4 with respect to the well part 8 is already at least substantially fixed in this state by the pins 42 and the holes 30, specifically in every conceivable spatial direction with the exception of a disassembly direction (direction counter to the arrow A in FIG. 5). The relative position of the battery element 4 with respect to the well part 8 is in particular at least substantially fixed in every direction along the contact surface formed by the base 38 of the well part 8, and in a rotary direction about an axis perpendicular to the said contact surface.

The other elastomer ring 22 is then inserted into a groove (not shown in any more detail) in the cover part 10 and the cover part 10 is inserted into the well part, the pins 42 now being accommodated in the bores 43 of the cover part 10. As can be seen from FIG. 4, five pins are provided in the upper region of the well part 8, which pins lie outside the extent of the edge region 28 of the battery element 4 but are each accommodated in further bores 43 in the cover part 10. The cover part 10 is fixed to the well part 8 by known fastening means such as screws (not shown in any more detail here) or by corresponding shaping of the edge web 34 of the well part 8 and of the edge of the cover part 10, which can be formed for example in such a manner that the edge web 34 has a peripheral or locally limited, inwardly pointing bead, which is overcome in the assembly direction by the cover part 10 during assembly, as a result of which the cover part 10 latches in the well part 8.

Within the context of the present invention, the battery cell 2 is an example of an electrochemical cell, the battery unit 4 is an example of an electrical unit, the well part 8 is an example of a first frame part, the cover part 10 is an example of a second frame part, and the pins 42 and holes 30 are an example of shape features which match one another and engage in one another in such a manner that a relative position of the electrical unit with respect to the first frame part is at least substantially fixed at least in a state in which the clamping assembly of the frame parts and electrical unit is released. Within the context of the invention, the holes 30 are in particular examples of recesses which are formed in an edge region of the electrical unit, and the pins 42 are examples of elevations which fill the recesses. The elastomer rings 22 are furthermore examples of a soft component within the meaning of the invention.

In a modification, the pins 42 can also be replaced by integrally formed elevations (knobs) in the contact surface of the well part 8, pins or elevations can also be provided in the cover part 10, which are accommodated in corresponding bores or depressions in the well part 8 and have a corresponding part in the hole pattern of the holes 30 in the edge region 28 of the battery element 4.

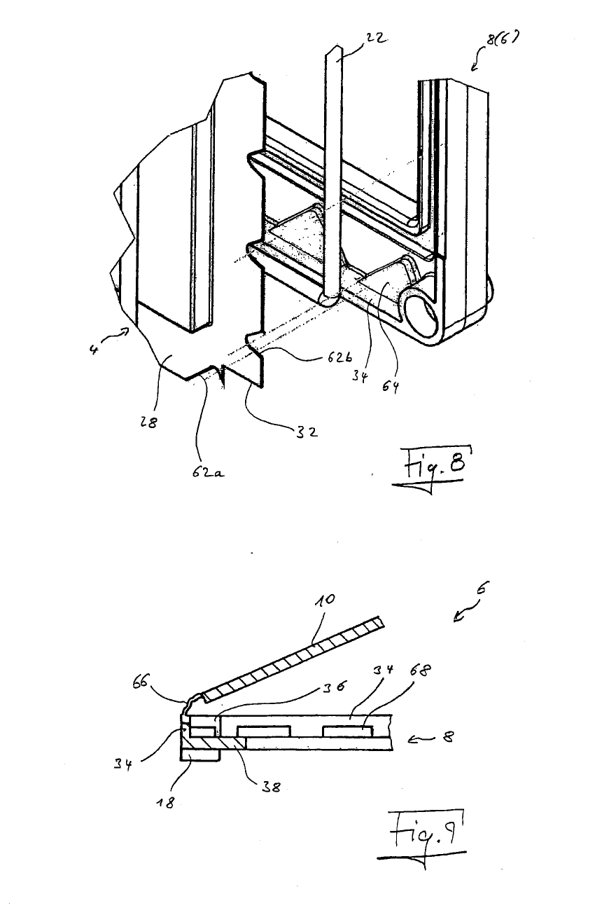

FIG. 6 shows a sectional view of an extract of a configuration of shape features of a battery cell according to a variant of the present invention, the sectional plane running through the edge region 28 parallel to an outer contour of the central part 26 of the battery unit 4. The course of the section and the viewing direction in FIG. 6 are indicated in FIG. 1 by arrows VI with a dash-dotted line. The figure shows a short section of the base 38 of the well part 8, an opposite section of the cover part 10 and a section of the edge region 28 of the battery element 4 lying therebetween.

According to the illustration in FIG. 6, the edge region 28 has embossed portions 44, which give it a wave-shaped pattern. Corresponding depressions 46 are formed in the base 38 of the well part, which follow exactly the course of the embossed profile of the edge region 28 of the battery element 4. The inside (clamping surface) of the cover part 10 is smooth in the variant shown, but in a modification can have elevations which follow the course of the embossed profile of the edge region 28 of the battery element 4.

The figure shows the individual components in a non-clamped state. During assembly, first the battery element 4 is placed into the well part 8 in such a manner that the wave profile (embossed portions 44) fits exactly into the depressions 46. If the embossed portions 44 are formed at least on two adjacent sides of the edge region 28, that is for example in the lower edge region and at least in the right-hand or left-hand edge region, the relative position of the battery element 4 with respect to the well part 8 is already at least substantially fixed in such an intermediate assembly state. The wave profile is preferably formed in the lower left-hand and right-hand edge region 28, that is, in particular in the edge regions in which the conductors 12, 14 are not formed.

In this variant, the embossed portions 44 and the depressions 46 are an example of shape features which match one another and engage in one another in such a manner that a relative position of the electrical unit with respect to the first frame part is at least substantially fixed at least in a state in which the clamping assembly of the frame parts and the electrical unit is released.

FIG. 7 shows a cross section through the edge region and a short section of the central part of a battery element 4 with the frame parts 8, 10 in cross section, in order to show a further variant of the present invention. The course of the section and the viewing direction in FIG. 7 are indicated in FIG. 1 by arrows VII with a dash-dotted line.

Also shown is a construction of the battery element 4, which is at least substantially exemplary for the whole application, having a film stack 48 and the wrapper films 50, 52 which wrap the latter and join outside the film stack 48 to form the edge region 28.

According to the illustration in FIG. 7, the well part 8 in the cross section shown here has a through-hole 54 in its base. A protrusion 56 protrudes inside the through-hole 54. The cover part 10 has a nose 58, which projects through corresponding holes inside the edge region 28 of the battery element 4 into the through-hole 54 in the well part 8. The nose 58 can be shaped to a certain extent and has a notch 60, which snaps in during assembly with the protrusion 56 in the through-hole 54. This is an example of a sprung locking device within the meaning of the present invention, which folds in during assembly of the first and second frame parts and thereby prevents the first frame part from becoming detached from the second frame part. This locking device is at the same time realised by shape features, namely the nose 58 and a bore (not shown here) inside the edge region 28 of the battery element 4.

In this variant, the nose 58 with the notch 60 and the protrusion 56 in the through-hole 54 are examples of a sprung locking device within the meaning of the invention. The nose 58 itself is a shape feature within the meaning of the invention, which engages with a shape feature (a bore) in the edge region 28 of the battery unit 4 in such a manner that a relative position of the electrical unit with respect to the first frame part is at least substantially fixed at least in a state in which the clamping assembly of the frame parts and electrical unit is released.

Of course, the snap device of the nose can also be shaped differently, as will become apparent to a person skilled in the art proceeding from the technical teaching described here.

FIG. 8 shows a detailed perspective view corresponding to FIG. 5 of a bottom right-hand corner of the battery cell 2 in a further variant.

In this variant, the edge region 28 of the battery unit 4 has a series of wedge-shaped cut-outs or notches 62a (in the lower edge region), 62b (in the lateral edge region) instead of a hole pattern.

The well part 8 of the frame 6 has a series of wedge-shaped elevations 64, the shape of which corresponds to the shape of the notches 62a, 62b in the edge region 28 of the battery unit 4, instead of pins.

When the battery unit 4 is inserted into the well part 8, the battery unit 4 with its notches 62a, 62b is directed towards the elevations 64 of the well part 8 and is thus fixed in all spatial directions (with the exception of a disassembly direction).

The notches 62a, 62b and elevations 64 are shape features within the meaning of the invention. In particular, the notches 62a, 62b are recesses and notches on the edge within the meaning of the invention.

Without limiting the generality, the top row of pins (42 in FIG. 4), which are not provided to engage with the battery unit 4, are present to make aligning the cover part 10 easier.

FIG. 9 shows a cross section through an edge region of a frame 6 in a battery cell (2) in a further variant of the present invention. The course of the section and the viewing direction in FIG. 9 are indicated in FIG. 1 by arrows IX with a dash-dotted line. In the figure, a battery unit (4) has been omitted to make the illustration simpler and clearer.

According to the illustration in FIG. 9, in this variant the well part 8 and the cover part 10 of the frame 6 are in one piece, a connection between the parts 8, 10 being realised by a hinge 66. The hinge 66 is a thin connection, which attaches in the upper edge region of the edge web 34 of the well part 8, and is preferably broken several times over the length of the edge web 34.

After insertion of a battery unit (4, e.g. FIG. 4) and alignment to shape features such as elevations 68, which are formed on the side of the well part 8, the cover part 10 is swung onto the well part 8 by the hinge 66 and fastened. Finally, the cover part 10 can rest on the elevations 68.

The hinge 66 is a hinge device within the meaning of the invention. In one modification, the parts of the frame can be in two parts and the hinge device can be realised by hinge bolts which are arranged in one of the well part 8 and the cover part 10.

Although the present invention has previously been described with reference to concrete exemplary embodiments in terms of its essential features, it goes without saying that the invention is not limited to these exemplary embodiments, but rather can be modified and expanded in the scope and field predetermined by the patent claims.

For example, the holes 30 in the edge region 28 of the electrical unit 4 can be modified so that they are open towards the edge and thus form notches on the edge which fit correspondingly shaped elevations on the side of the well part 8.

The elastomer rings 20 have been described with a round cross section; their configuration is however not limited to this. The cross section of the elastomer rings 20 can in modifications also be arrow-shaped, flatly rectangular, vertically semicircular or the like.

In addition to the elastomer rings 20, a further elastomer component, for example consisting of a foam, rubber, foam rubber or the like, can be provided, which supports the main part 26 of the battery element 4 laterally against the frame 6. As a volume reserve, corresponding cut-outs can be provided in the frame parts 8 and/or 10.

### LIST OF REFERENCE NUMBERS

2 Battery cell

4 Battery element

6′ Frame

8 Well part

10 Cover part

12 Positive conductor

12a Bore

14 Negative conductor

14a Bore

16 Assembly bore

18 Knobs

20 Depression

22 Elastomer ring

24 Groove

26 Central part

28 Edge part

30 Hole

32 Notch

34 Edge web

36 Ring web

38 Base

40 Window

42 Pin

43 Bore

44 Embossed portion

46 Depression

48 Film stack

50 Envelope film

52 Envelope film

54 Through-hole

56 Protrusion

58 Nose

60 Notch

62a Notch

62b Notch

64 Elevation

66 Hinge

68 Elevation

A Assembly direction

T Thickness

It is explicitly pointed out that the preceding list of reference numbers is an integral part of the description.

1. An electrochemical cell, comprising:
an electrical unit,
a first frame part, and
a second frame part,
wherein the electrical unit is clamped in the area of the clamping surfaces between the first frame part and the second frame part,
wherein the electrical energy unit and the first frame part have shape features which match one another and engage in one another in such a manner that a relative position of the electrical unit with respect to the first frame part is at least substantially fixed, at least in a state in which the clamping assembly of the frame parts and the electrical unit is released.

2. The electrochemical cell according to claim 1, wherein the shape features of the electrical unit are formed in an electrically inactive edge region of the electrical unit.

3. The electrochemical cell according to claim 2, wherein the electrical unit has an electrochemically active part, which defines a substantially square, in particular flat basic shape, is formed from a film stack or film coil and is surrounded in a leakproof manner by a film-like, insulating wrapper, the wrapper forming the edge region.

4. The electrochemical cell according to claim 1, wherein the shape features of the electrical unit have recesses which are formed in an edge region of the electrical unit, and for the shape features of the first frame part to have elevations which fill the recesses.

5. The electrochemical cell according to claim 4, wherein the elevations and the recesses have an at least substantially circular cross section.

6. The electrochemical cell according to claim 4, wherein the elevations are integrally formed on the respective frame part.

7. The electrochemical cell according to claim 4, wherein the elevations are elements, which are accommodated in receptacles in the respective frame part.

8. The electrochemical cell according to claim 4, wherein the recesses have notches on the edges and the notches to have a shape which follows the recesses.

9. The electrochemical cell according to claim 4, wherein the second frame part has depressions which accommodate the elevations of the first frame part.

10. The electrochemical cell according to claim 1, wherein the shape features of the electrical unit have embossed portions which are formed in an edge region of the electrical unit, and the shape features of the first frame part are elevations and/or depressions which follow the embossed portions.

11. The electrochemical cell according to claim 1, wherein a soft component is provided between the clamping surfaces of the electrical unit and the frame parts, wherein the soft component is elastically compressed in a state in which the clamping assembly of the frame parts and electrical unit is produced.

12. The electrochemical cell according to claim 1, wherein the first frame part and the second frame part are connected to each other detachably, in particular by screw fastening, or non-detachably, in particular by riveting.

13. The electrochemical cell according to claim 1, wherein a sprung locking device is provided, which snaps in when the first and second frame parts are joined and thereby prevents the first frame part from becoming detached from the second frame part.

14. The electrochemical cell according to claim 1, wherein the first frame part and the second frame part are connected to each other by a hinge device.

15. An arrangement of electrochemical cells, wherein the electrochemical cells are cells according to claim 1.

16. The electrochemical cell according to claim 3, wherein edge region projects from narrow sides of the square basic shape.

17. The electrochemical cell according to claim 5, wherein the recesses form a hole pattern.

18. The electrochemical cell according to claim 7, wherein elements are pins or bolts, which are produced from a less resilient material than the frame parts.

19. The electrochemical cell according to claim 10, wherein the second frame part has depressions and/or elevations which follow the embossed portions.

20. The electrochemical cell according to claim 13, wherein the locking device is realised by elevations and depressions in the first and second frame parts.
